(19) United States
(12) Patent Application Publication
(10) Pub. No.: US 2013/0226413 A1
(43) Pub. Date: Aug. 29, 2013

(54) Vehicle Safety System Optimization Using RFID Occupant Identification

(71) Applicants: Mark A. Cuddihy, New Boston, MI (US); Manoharprasad K. Rao, Novi, MI (US); Brian Robert Spahn, Plymouth, MI (US); Tai Luu, Westland, MI (US)

(72) Inventors: Mark A. Cuddihy, New Boston, MI (US); Manoharprasad K. Rao, Novi, MI (US); Brian Robert Spahn, Plymouth, MI (US); Tai Luu, Westland, MI (US)

(73) Assignee: FORD GLOBAL TECHNOLOGIES, LLC, Dearborn, MI (US)

(21) Appl. No.: 13/405,457

(22) Filed: Feb. 27, 2012

(51) Int. Cl. G06F 17/00

(52) U.S. Cl. 701/45

(57) ABSTRACT

A non-contact RFID reader reads a code contained on an RFID tag carried by a driver of a vehicle. The code is assigned to a specific individual expected to operate the vehicle. An electronic module in the vehicle contains a data file uniquely associated with the code, and the data file contains physical characteristics of the driver that may be pertinent to proper functioning of safety systems of the vehicle, such as weight, height, age, and sex. Performance parameters of restraints and/or other safety systems, such as an airbag associated with the driver's seating position are adapted in accordance with the physical characteristics in the data file. The RFID reader may read multiple tags on board the vehicle, so that restraints for multiple seating positions in addition to the driver's seat may be adapted to the individual occupying those positions.

### TECHNICAL FIELD

The present invention relates to an occupant safety system for a motor vehicle using an RFID tag carried by an occupant to identify the occupant and adapt safety system performance parameters.

### BACKGROUND

The performance of occupant safety systems used in motor vehicles, such as airbags and seatbelts, could be improved if the operating parameters of the system could be adapted or customized based upon the physical characteristics (such as weight, height, age, and sex) of a particular occupant or occupants travelling in the motor vehicle. For example, if it is known that a seat occupant is relatively small in stature, it may be beneficial to reduce the amount and/or rate of inflation of an airbag during a frontal crash.

Systems have been proposed that use various types of sensors to obtain physical information about seat occupants. A sensor that directly measures the weight of an occupant may not be accurate if in the seated position the occupant “off-loads” some portion of his/her weight onto the vehicle floor through his/her legs and feet. Other proposed sensors use more sophisticated technology such as vision, capacitance, and/or ultrasonic detection. Such non-contact sensors are still in development and, in some cases, have significant technical issues which must be overcome to make them practical on a wide scale. Characteristics such as age and sex must be determined indirectly.

### SUMMARY

In a disclosed embodiment, a method for improving occupant safety in a motor vehicle comprises using a non-contact reader to read or detect at least one code on at least one RFID tag carried by at least one vehicle occupant, accessing an electronic data file associated with the code, and adapting at least one performance parameter of at least one occupant safety system in accordance with information contained in the data file. The code is uniquely assigned to the occupant to whom it is issued, and the data file contains physical characteristics of the occupant that may be pertinent to proper functioning of the occupant safety systems. This allows the safety systems associated with the seating position used by the occupant to be adapted for operation in a manner that provides optimum safety benefit for that specific occupant.

The physical characteristics may, for example, include the weight, height, age, and/or medical condition of the occupant. The occupant safety system may be an airbag, and the performance parameter to be adjusted may be an amount of inflation and/or a speed of inflation of the airbag.

In another disclosed embodiment, the method further comprises using the non-contact reader to read a second code on a second RFID tag carried by a second vehicle occupant, accessing a second electronic data file associated with the second code, and adapting performance parameters of a restraint associated with a seating position of the second occupant in accordance with data file information. The second code is assigned to the second occupant, and the second data file contains physical characteristics of the second occupant;

In another disclosed embodiment, apparatus for an automotive vehicle comprises an RFID tag containing a code assigned to an occupant of the vehicle, a non-contact reader in the vehicle and activated to read the code contained on the tag, and an electronic module containing a data file associated with the code. The data file contains physical characteristics of the occupant. An occupant safety system, such as for example an airbag associated with the seating position occupied by the occupant, has one or more performance parameters that may be adapted in accordance with the physical characteristics.

### BRIEF DESCRIPTION OF THE DRAWINGS

FIG. 1 is a schematic diagram of a motor vehicle and carrier having a RFID reader integrated with a restraints control module;

FIG. 2 is a logic flow chart of a first method for adapting safety system performance;

FIG. 3 is a logic flow chart of a second method for adapting safety system performance; and

FIG. 4 is a logic flow chart of a third method for adapting safety system performance.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

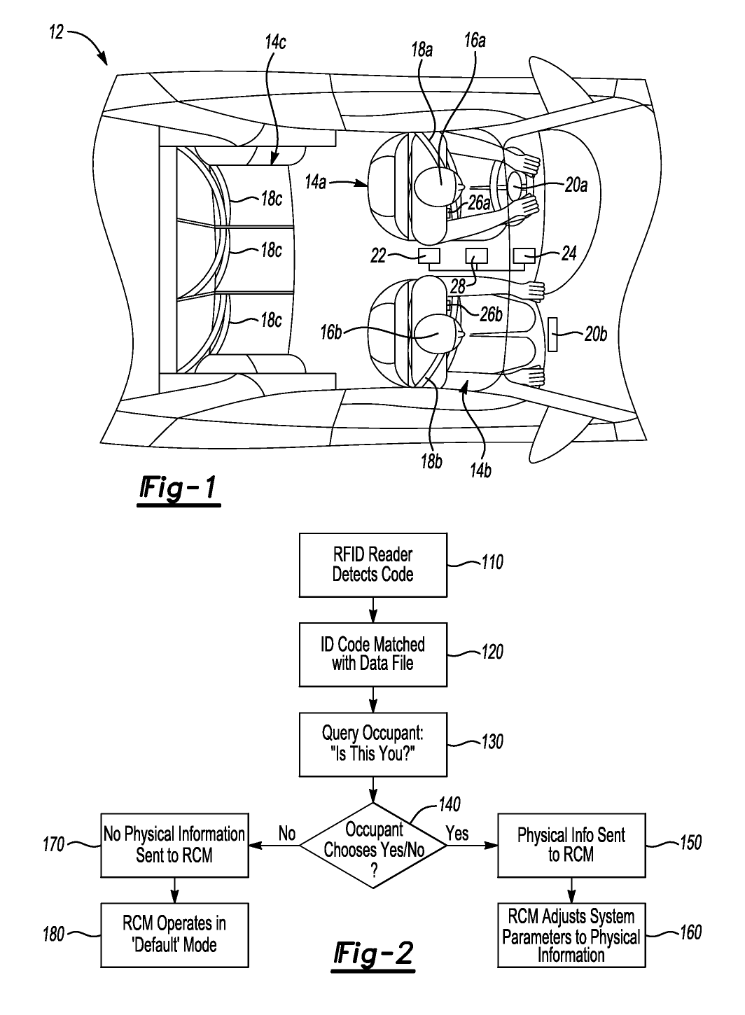

Referring to FIG. 1, a vehicle 12 includes a driver's seat 14a occupied by a driver 16a, a front passenger seat 14b occupied by a passenger 16b, and a rear seat 14c which may include multiple seating positions (shown unoccupied). Seats 14a-14c are equipped with seat belts 18a-18c respectively, and front row seats 14a, 14b are equipped with airbags 20a, 20b respectively. Other occupant safety devices well-known in the automotive field (such as rear seat airbags, side airbags, curtain airbags, deployable bolsters, etc.) may also be present but are not shown for clarity. A restraints control module (RCM) 22, as is well-known in the automotive safety industry, receives signals from sensors (not shown) and applies programmed logic to control the operation of safety systems such as seat belts 18a-c and airbags 20a, 20b.

A non-contact radio frequency identification (RFID) reader 24 is located within or adjacent to the passenger compartment of vehicle 12 to be able to read one or more RFID tags 26a, 26b present in the vehicle passenger compartment. FIG. 1 shows RFID tags 26a, 26b carried by driver 16a and front seat occupant 16b. While this disclosure refers primarily to driver 16a and restraints 18a, 20a related to the driver, it is understood that the method and apparatus disclosed herein may be extended to any other seating position equipped with or otherwise affected by occupant safety systems.

An RFID tag, as is well known in the art, responds to interrogation by an RFID reader by transmitting a signal containing information stored or encoded on the tag. RFID tags may be passive or active tags, but it is most advantageous with the passive type. Passive RFID tags require no battery or other power source, and are therefore very thin and small and may be conveniently attached to an object always carried by driver 16a, front seat passenger 16b, or other occupant when operating or riding in the vehicle. For example, RFID tags may be affixed to a key fob, a vehicle operator's license, or to some other item habitually carried in the driver's wallet or purse. In FIG. 1, for example, RFID tags 26a, 26b are schematically shown as carried on the person (in the pocket of a piece of clothing, for example) of driver 16a and passenger 16b.

Each RFID tag 26a, 26b contains an identification code that is uniquely assigned to a particular individual expected to drive or ride in the vehicle. If vehicle 12 is used primarily by members of a group (such as a family, household, or business) each member may be assigned a tag containing a unique identification code associated with the identity of each member.

When an RFID tag 26a, 26b is carried by an occupant (driver or passenger) into vehicle 12 and comes within the detection range of non-contact RFID reader 24, the reader detects the code carried on the tag. RFID reader 24 communicates with an operator interface module (OIM) 28 enabling two-way communication with vehicle occupants. OIM 28 may include a display/touch screen and/or a voice recognition/communication system.

Reader 24 may emit an interrogation signal continuously, intermittently, or when triggered by some occurrence or action such as a vehicle door being opened and/or closed. Any RFID tag 26a, 26b interrogated responds by transmitting its ID code, which is received by reader 24. Upon detection of the code, a data file associated with that code is accessed. The data file contains information related to one or more physical characteristics of the individual to whom the code is assigned. The data file may be stored in memory of OIM 28, reader 24, RCM 22, or any suitable electronic component that is in communication with the RCM.

Among physical characteristics that may be significant to proper functioning of the occupant safety systems are the occupant's weight, height, age, and sex. Other physical characteristics may also relate to existing medical conditions, injuries, physical limitations, and/or pregnancy. All physical characteristics entered into the data file are uniquely correlated with the identification code contained on a particular RFID tag associated with the vehicle occupant who is expected to carry that tag.

The physical characteristics saved in the data file are communicated to RCM 22, preferably at the beginning of a driving cycle, and the RCM uses that information to adapt one or more operating parameters of safety systems associated with the occupant. For example, RCM 22 may direct a less than full inflation of airbag(s) 20a and/or 20b if the data file identifies the occupant of the seat as a small-statured person (5^{th} percentile female, for example).

The flow chart shown in FIG. 2 depicts a method of operation consistent with the apparatus of FIG. 1. The method begins when the RFID reader receives the code from an RFID tag present in the vehicle, block 110. For simplicity of description, it is assumed that only one RFID tag is present in the passenger compartment and that it is carried by the driver. If a valid ID code is detected, the code is matched with the data file associated with the code and containing physical characteristics of the individual to whom the code is assigned (block 120).

At block 130, the driver is queried as to whether she/he is the individual to whom the code is assigned, asking the driver to confirm their identity. This query provides an additional safety precaution to reduce the chance that the driver will have incorrect safety system parameters set because he/she is inadvertently carrying an RFID tag bearing a code associated with a different person.

At block 140, the driver responds to the query by selecting “YES” or “NO.” This response may be made by actuating a button, touching a touch screen, or verbally if the vehicle is equipped with a voice recognition system. If the driver responds “YES,” the physical characteristics contained in the data file are sent to the RCM (block 150). The RCM adjusts or adapts the performance parameters of the appropriate occupant safety systems in a manner expected to provide maximum benefit for an individual having those characteristics (block 160).

Returning to block 140, if the driver responds “NO,” no data file message containing physical characteristics is sent to the RCM (block 170) so that the RCM operates in a “default” mode (block 180). In the “default” mode, the safety systems operate using performance parameters expected to protect the broadest range of possible/expected vehicle occupants. As an alternative to operating in the “default” mode, it is possible to prompt the occupant to enter their own physical information.

If the reader detects a tag bearing a code for which no data file exists, such as may occur the first or initial time an individual enters the vehicle with a newly-assigned tag, the occupant is prompted to create the data file by inputting their own physical information. This may be accomplished, for example, using an operator interface module 28.

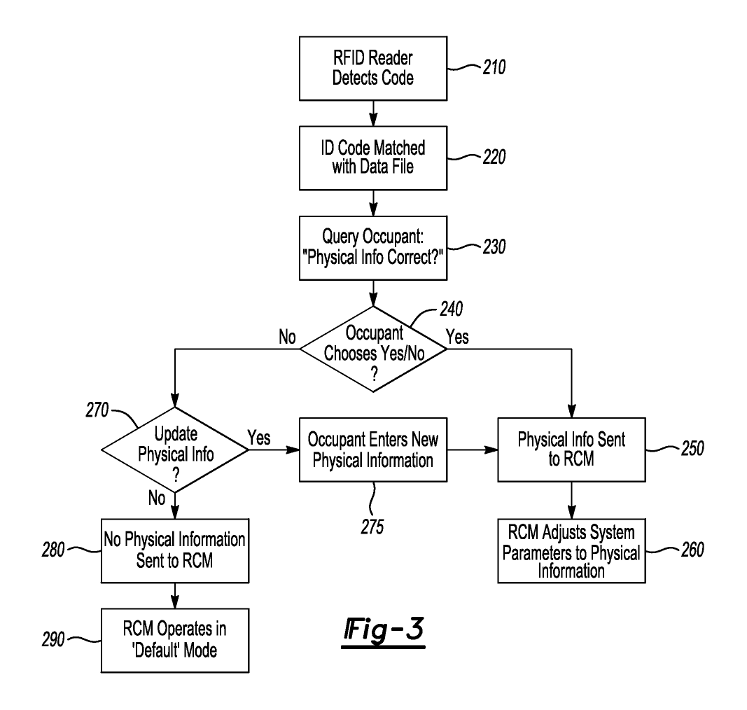

Referring now to FIG. 3, another method of operation of an occupant safety system is disclosed. As with the FIG. 2 method, for simplicity of description it is assumed that only one RFID tag is present in the passenger compartment and that it is carried by the driver. At blocks 210 and 220, the RFID reader detects an identification code from the tag and matches the code the appropriate data file. At block 230, the driver is queried as to whether the physical characteristics contained in the data file are correct. Such a query may take the form of presenting the height, weight, age, sex, and/or other physical conditions associated with the ID code and asking the driver if these are accurate. If the driver selects “YES” the method progresses to blocks 250 and 260 where the physical information contained in the data file is sent to the RCM and the performance parameters of the safety systems are adjusted accordingly.

If at block 240 the driver responds “NO” (the physical information is not correct and/or requires updating), the method progresses to block 270 and the driver is prompted to enter new or updated physical information. If the occupant does not enter any updates (“NO”), no physical information is sent to the RCM and the safety systems operate in a “default mode.” If at block 270 the driver agrees (“YES”) to update the physical information, at block 275 the driver is able to update the physical information in the data file interactively using OIM 28 and this information is sent to the RCM for use in making safety system parameters decisions.

The query of block 230 may be presented to an occupant periodically, and the time period may be pre-set by the system designer and/or it may be changed/selected by the occupant or vehicle owner.

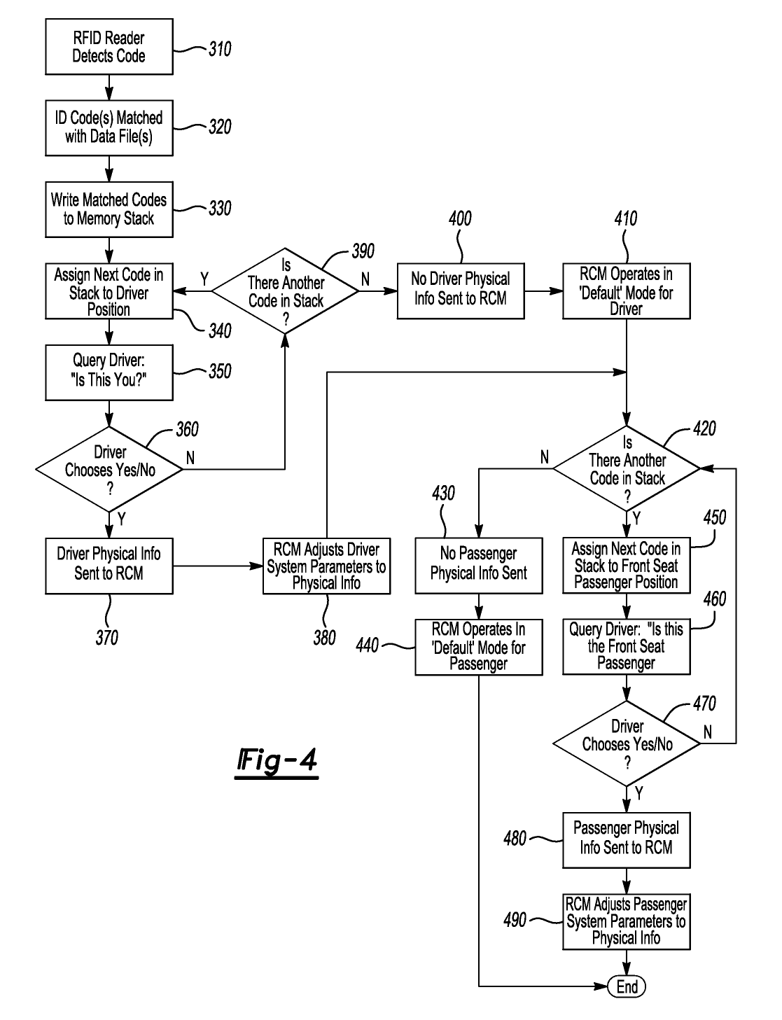

FIG. 4 is a flow chart of a method for adapting safety settings for a vehicle driver and at least one other vehicle occupant. For simplicity of description, it is assumed that the other occupant is in the front passenger seat, but the method may apply to other seating positions and/or be extended to more than two seating positions.

The method begins when the RFID reader receives the codes from one or more RFID tags present in the vehicle, block 310. All valid codes detected are matched with the respective data file associated with the code, each of the data files containing physical characteristics of the individual to whom the code is assigned (block 320). The detected ID codes are written to a memory stack in sequence (block 330).

At block 340 the next ID code in the memory stack (which in this first iteration is the first or top-most code in the stack) is assigned to the driver's seat position, and at block 350 the driver is queried as to whether she/he is the individual to whom the code is assigned.

At block 360, the driver responds to the query by selecting “YES” or “NO.” If the driver responds “YES,” the physical characteristics contained in the data file associated with the first code in memory stack are sent to the RCM (block 370). The RCM adjusts or adapts the performance parameters of the occupant safety systems related to the driver's seat in a manner expected to provide maximum benefit for an individual having those characteristics (block 380).

Returning to block 360, if the driver responds “NO,” the memory stack is checked to see whether there is another ID code present (block 390). If only one RFID tag was detected the result of block 360 is “NO,” no data file message containing physical characteristics is sent to the RCM (block 400), and the RCM operates in a “default” mode (block 410) for the driver's seat position. In the “default” mode, the safety systems operate using performance parameters expected to protect the broadest range of possible/expected vehicle occupants. As an alternative to operating in the “default” mode, it is possible to prompt the driver to enter his/her own physical information, as described in relation to FIG. 2.

If at block 390 there is another ID code in the stack (“YES”), the next ID code is assigned to the driver position (block 340) and the driver is queried (block 350) whether she/he is the individual to whom the code is assigned. If more than two uniquely-coded RFID tags were detected by the reader at step 310, this may again result in a “NO” selection by the driver, and the loop will repeat, sequencing through each ID code in the memory stack and querying the driver until either the driver selects “YES” at block 360 or there are no more ID codes in the memory stack and the RCM operates in the “default” mode for the driver position.

After the RCM operating mode of the restraint(s) for the driver's seat position has been decided (block 380 or block 410), the stack is checked again for another code (block 420). If no other code is present (block 420, “NO”), no physical information is relayed to the RCM for the passenger seat position (block 430) and the RCM controls the restraints for that position in accordance with the “default” mode. If there is another ID code in the stack (block 420, “YES”), the next ID code (which in this first iteration is the first or top-most code in the stack) is assigned to the passenger seat position (block 450) and the driver is queried (block 460) whether the occupant of the front passenger seat is the individual to whom that code is assigned. This query may be made to and/or answered by the passenger seat occupant, if desired.

If the driver selects “NO” the method returns to block 420 and the memory stack is checked for another ID code, the sequence repeating until the driver has been queried about all of the codes in the stack. If the driver selects “YES” in response to one of the queries, the physical characteristics contained in the data file associated with that code are sent to the RCM (block 480) and the RCM adjusts or adapts the performance parameters of the occupant safety systems related to the passenger seat in a manner expected to provide maximum benefit for an individual having those characteristics (block 490).

It is possible for the an occupant safety system and method as described herein to associate RFID tags with any number of occupant seating positions for which the RCM is able to apply occupant-specific safety parameters. The occupant seating positions may be in any seating row of a multi-row vehicle.

A data file for a particular individual may contain information indicating that she/he is particularly vulnerable to injury or otherwise requires special care (such as infants, young children, the elderly, or infirm). In this case, in addition to adjusting performance parameters of the safety systems as appropriate to accommodate that vulnerability, a message may be presented to the vehicle operator or other occupant (via the OIM 28, for example) to remind her/him of the vulnerable individual's condition.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method comprising:
using a non-contact reader to read an RFID tag carried by a vehicle occupant, the tag containing a code assigned to the occupant;
accessing an electronic data file associated with the code and containing physical characteristics of the occupant;
querying the occupant regarding the data file;
receiving a response to the query from the occupant; and
adapting a performance parameter of an occupant safety system in accordance with the response.

2. The method of claim 1 wherein the physical characteristics include at least one of a weight, a height, an age, a sex and a medical condition of the occupant.

3. The method of claim 1 wherein the querying step comprise:
prompting the occupant to confirm an identity associated with the code after the non-contact reader has read the code.

4. The method of claim 1 wherein the querying step comprises:
prompting the occupant to update the physical characteristics stored in the data file.

5. The method of claim 1 wherein the querying step comprises:
prompting the occupant to confirm that the physical characteristics stored in the data file are correct.

6. The method of claim 1 wherein the querying step comprises:
prompting the occupant to create the data file upon an initial reading of the code by the non-contact reader.

7. The method of claim 1 wherein the electronic data file is stored on-board the vehicle.

8. The method of claim 1 wherein the performance parameter is at least one of an amount of inflation and a speed of inflation of an airbag.

9. The method of claim 1 further comprising:
using the non-contact reader to read a second RFID tag carried by a second vehicle occupant, the second tag containing a second code assigned to the second occupant;
accessing a second electronic data file associated with the second code, the second data file containing physical characteristics of the second occupant; and
adapting a performance parameter of a restraint associated with a seating position of the second occupant in accordance with the physical characteristics of the second occupant.

10.-14. (canceled)

15. A method for improving occupant safety in a motor vehicle comprising:
using a non-contact reader in the vehicle to read an identification code of an RFID tag, the identification code uniquely associated with an occupant of the vehicle;
accessing a data file stored electronically on-board the vehicle and associated with the code, the data file describing physical characteristics of the occupant;
communicating a prompt to the occupant to confirm an identity associated with the code; and
adapting a setting of an occupant safety system in accordance with at least one of the physical characteristics and an occupant response to the prompt.

16. The method of claim 15 further comprising:
prompting the occupant to update the physical characteristics stored in the data file.

17. The method of claim 15 further comprising:
prompting the occupant to confirm that the physical characteristics stored in the data file are correct.

18. The method of claim 15 further comprising:
prompting the occupant to create the data file upon an initial reading of the code by the non-contact reader.

19. The method of claim 15 wherein the setting is at least one of an amount of inflation and a speed of inflation of an airbag.

20. The method of claim 15 further comprising:
using the non-contact reader to read a second identification code of a second RFID tag, the second identification code uniquely associated with a second occupant of the vehicle;
accessing a second data file stored electronically on-board the vehicle and associated with the second code, the second data file describing physical characteristics of the second occupant;
prompting at least one of the occupants to confirm an identity associated with the second code; and
adapting a performance parameter of a restraint associated with a seating position of the second occupant in accordance with the physical characteristics of the second occupant.
